(19) United States
(12) Patent Application Publication
(10) Pub. No.: US 2011/0274902 A1
(43) Pub. Date: Nov. 10, 2011

(54) DERIVED TIMBER MATERIAL BOARD AND A METHOD FOR PRODUCING A DERIVED TIMBER MATERIAL BOARD

(75) Inventors: Joachim Hasch, Berlin (DE); Dirk Grunwald, Braunschweig (DE)

(73) Assignee: KRONOTEC AG, Luzern (CH)

(21) Appl. No.: 13/143,777

(22) PCT Filed: Feb. 24, 2010
(86) PCT No.: PCT/EP10/01139

§ 371 Date: Jul. 8, 2011

(30) Foreign Application Priority Data
Feb. 26, 2009 (EP) 09002727.7

(51) Int. Cl. B32B 21/04; B32B 7/02; B29C 44/12; B32B 5/20

(52) U.S. Cl. 428/218; 428/304.4; 428/317.9; 264/45.3

(57) ABSTRACT

A derived timber material board, having at least three layers made of a derived timer material is provided. At least a middle layer thereof is made of a mixture of derived timber material and a foamed plastic. The middle layer additionally has at least one foamed natural material.

### BACKGROUND OF THE INVENTION

1. Field of the Invention

The invention relates to a woodbase board having three or more layers of a woodbase material, the at least one central layer of which consists of a mixture of woodbase material and a foamed plastics material, and also to a process for producing a woodbase board.

2. Discussion of Background Information

A woodbase board of this type is known for example from DE 20 2006 020 503 U1, which is hereby fully incorporated herein by reference. To make this woodbase board as light as possible, the central layer contains a lightweight woodbase material comprising 30 to 95 weight percent of wood particles having an average density of 0.4-0.85 g/cm³. Based on the lightweight woodbase material, up to 20 weight percent of poly-styrene and/or styrene copolymer is present as filler, the filler having a bulk density of 10 to 100 kg/m³. From 2.5 to 50 weight percent of binder is also present, and the average raw density of the lightweight woodbase material is less than 600 kg/m³.

As the raw density of the lightweight woodbase board decreases, the mechanical-technological parameters also decrease, so that boards of this type cannot be used below an average raw density of 500 kg/m³.

Woodbase boards are board-shaped plywood, chipboards, such as flat pressed boards, extruded boards, OSB boards or cabinetmaking boards, wood fiber fiberboards, for example MDF or HDF fibers, and also other woodbase boards, such as laminated wood boards, laminated wood moldings or else pressed laminated wood. Especially woodbase boards in the furniture industry present the problem that stable boards are relatively heavy because of their thickness, which can lead to transportation problems for self-assemblers in particular.

EP 1 561 554 B1 discloses a woodbase board incorporating, between two woodbase layers, a layer of a foamed plastics material, said layer of plastics material forming the core of the woodbase board. The upper and lower sides of the woodbase board consist of wood fibers or wood shavings. In this woodbase board, the core is crosslinked with wood fibers or wood shavings. To achieve improved bonding of the foamed plastics material to the woodbase materials, a mixture of woodbase materials and granular plastics material may be spread between the two outer woodbase layers.

JP 2002-338373 A1 describes a process for producing a wooden cement board which has improved heat-insulating properties. In this process, a mixture of wooden raw material and cement is introduced into a form. Foamed beads of resin are scattered onto this first layer. This layer of foamed beads of resin then has a layer of wooden raw material and cement applied to it again.

This intermediate product is compression molded in a press so that the foamed resin remains in the center layer of the compression molding. The compression molding is subsequently exposed to high-temperature steam in a steam press so that the foamed particles of resin undergo curing.

DE 1 185 806 B describes a process for producing a sandwich board having a core layer of foamed plastics material and supporting layers of a fibrous cement composition which can be applied on both sides, in which case the supporting layers can also consist of a mixture of cement and woodwool.

U.S. Pat. No. 5,554,429 A describes a woodbase board having a core layer comprising at least one OSB board, produced with a foaming adhesive and provided with at least one surface layer of a further OSB board, the surface layer being adhered to a surface of the core layer. The foaming adhesive can be a polyurethane adhesive for example. The board is produced in a hot press at a pressure of about 1 to 2 MPa and a temperature in a range between 150 and 200° C., the foaming of the foam taking place in the press.

DE 42 26 988 A1 describes a molded article formed from natural fibers impregnated with a foamed synthetic resin, and consisting of two outer layers of natural fibers and a center layer enclosed by the outer layers. The center layer is formed at least in part of a foamed synthetic resin. And the center layer may contain inter alia wood splinters, wood chips, wood bark and also needles from conifers as filler. The mixture of natural fibers for the outer layers and synthetic resin for the center layer is laid into a heated mold. After the heated mold has been closed, the temperature of the synthetic resin is brought to, for example, 60° C., which causes the resin to foam up and infiltrate the layers of fiber.

EP 1 253 257 A1 describes a process for producing a flat element and also a woodbase board having a layer of foamed polystyrene between two woodbase boards. Two ready-produced woodbase boards are bonded together for this via an adhesive together with insulating boards.

### SUMMARY OF THE INVENTION

The problem addressed by the present invention is that of improving the woodbase board described at the beginning to the effect that any further reduction in raw density will preserve good mechanical/technical parameters and reduce the emission of aldehydes. This problem is solved when a woodbase board of the type defined additionally includes at least one foamed natural material of construction in the at least one central layer.

The natural material of construction may be, for example, maize, rice, wheat or a mixture thereof. The natural material of construction has the advantage of higher strength compared with conventional materials of construction but lower density than the wood fibers or wood shavings. This makes it possible to achieve an average raw density of less than 500 kg/m³, while the raw density of the surface layers is greater than 500 kg/m³.

Preferably, the raw density of the center layer is less than 450 kg/³ and the deviation from the average raw density does not exceed plus/minus 50 kg/m³.

The central layer may include fibrous or filamentary constituents by way of further reinforcement. These constituents preferably consist of natural materials of construction, more particularly flax.

However, the fibrous or filamentary constituents may also consist of plastics material, more particularly of carbon, PE, PP, PET, of glass fibers or of two components.

The surface layer preferably utilizes conventional species of wood. The center layer preferably utilizes woods of low raw density, for example poplarwood or alderwood. However, other suitable species of wood can also be used.

The central layer at least may include additional fillers composed of plastics material, preferably based on polyurethane foams and/or polystyrene foams.

The central layer may additionally contain latent heat storage media to increase the heat storage capacity of the woodbase board. Useful latent heat storage media include plastics capsules having a core of purely wax, as marketed for example by BASF under the designation “Micronal PCM”. When the temperature in the room rises beyond the 23 or 26 degrees Celsius defined as the switching temperature in the course of the production of the microscopically small capsules of plastics material, the wax in the interior of the microcapsules liquefies and absorbs the excess heat in the room. When the temperature decreases, the wax solidifies and the capsules reemit their heat back to the room. The periodic sequence of melting and solidifying is ensured by the natural temperature differences between night and day. The latent heat storage media thus contribute to absorbing daytime temperature spikes.

The resinated wood fibers, wood shavings or wood strands are formed into layers together with the fillers and the further lightweight components and subsequently joined together with each other in a hot-press process by application of pressure. Suitable resination glues include UF, MUF, MUPF, PF, TF, which may all optionally include a protein fraction, for example pPF, adhesives based on soya, pMDI or mixtures thereof.

A process for producing a woodbase board consisting of three or more layers wherein each individual layer is formed with from a resinated wooden material was is characterized by adding foamable natural products, more particularly maize, rice or wheat, to the at least one central layer, molding the formed layers into a board of the desired thickness, and foaming the natural products during the pressing step.

Instead of foaming up the natural products during the hot pressing, these can also be foamed up shortly beforehand. The same applies to the foaming plastics materials, too. Some natural constituents, for example maize, simply foam up as a result of heat in the press. Others, for example wheat or rice, usually contain too little water to be able to foam up in the press, and therefore have to be foamed up before being introduced into the central layer.

Preferably, the at least one central layer is also admixed with fillers of plastics material based on polyurethane foams or polystyrene foams, which foam up during pressing in addition to the natural products.

The natural products foam up by bursting open, filling the void spaces between the wood fibers or wood shavings as a result. The foamed natural products additionally have an aldehyde-scavenging effect. It is particularly advantageous that this effect is sustained owing to the fixed binding into the board matrix.

### BRIEF DESCRIPTION OF THE DRAWINGS

An exemplary embodiment of the invention will now be briefly elucidated using a drawing, where

FIG. 1 shows a plan view of the formed central layer of a woodbase board as far as the line of symmetry;

FIG. 2 shows the enlarged detail II of FIG. 1; and

FIG. 3 shows the raw density distribution of the woodbase board over its cross section.

### DETAILED DESCRIPTION OF THE PRESENT INVENTION

A woodbase board is produced by forming individual layers into a cake and then pressing the cake to the desired board thickness. The process of resinating the wood fibers or shavings, forming and pressing is long known. DE 10 2004 006 385 is referenced by way of example.

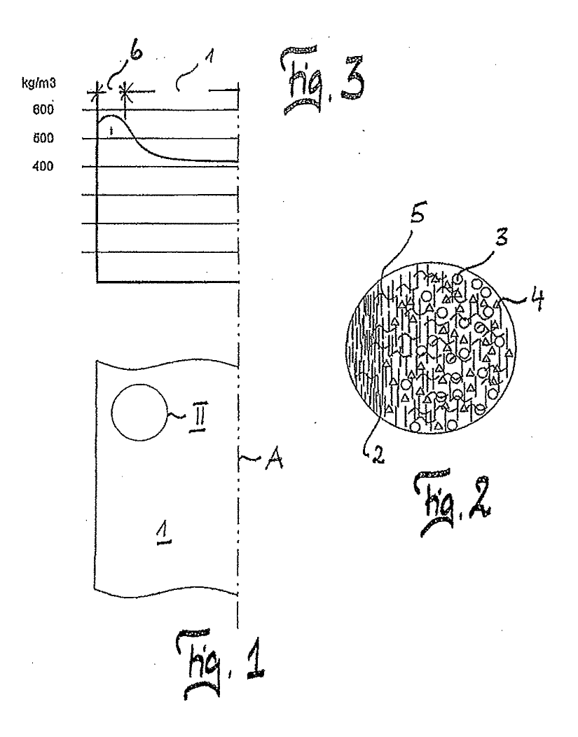

FIG. 1 shows a portion of the at least one central layer 1 of a woodbase board, formed symmetrically to the symmetry axis A. This center layer 1 consists of wood shavings or wood fibers 2, customary fillers 3, such as polystyrene, polyisocyanate or polyol and also a blowing agent. In addition, layer 1 contains foamable natural substances 4, such as maize, rice or wheat. Filamentary reinforcing fibers 5 are also provided. This center layer 1, which has been formed on a lower surface layer, has at least one upper surface layer formed on it, and the cake formed is then pressed.

FIG. 3 shows the raw density profile of the woodbase board of the present invention across its thickness. It is apparent that the surface layers 6 have a significantly greater density than the center layer 1.

1. A woodbase board having three or more layers of a woodbase material, at least one central layer of which comprises a mixture of woodbase material and a foamed plastics material, wherein the central layer additionally includes at least one foamed natural material of construction.

2. The woodbase board according to claim 1, wherein the natural material of construction is maize, rice, wheat or a mixture thereof.

3. The woodbase board according to claim 1, wherein the woodbase material of the central layer has a lower density than the woodbase material of outer layers.

4. The woodbase board according to claim 1, further comprising an average raw density of 500 kg/m³.

5. The woodbase board according to claim 4, wherein the raw density of the central layer is below 450 kg/m³.

6. The woodbase board according to claim 4, wherein the raw density of surface layers is above 500 kg/m³.

7. The woodbase board according to claim 4, wherein a deviation from the average raw density does not exceed plus/minus 50 kg/m³.

8. The woodbase board according to claim 1, wherein the central layer includes fibrous or filamentary constituents.

9. The woodbase board according to claim 8, wherein the fibrous or filamentary constituents includes natural materials of construction.

10. The woodbase board according to claim 8, wherein the fibrous or filamentary constituents comprises plastics material.

11. The woodbase board according to claim 9, wherein the fibrous or filamentary constituents comprise two components.

12. The woodbase board according to claim 1, wherein at least the central layer includes additional fillers composed of plastics material.

13. The woodbase board according to claim 1, wherein the central layer additionally includes latent heat storage media to increase the heat storage capacity.

14. The woodbase board according to claim 13, wherein the latent heat storage media are microencapsulated.

15. A process for producing a woodbase board comprising three or more layers, which comprises forming each individual layer of resinated wood fibers or wood shavings and adding foamable natural products, more particularly maize, rice or wheat, to at least one central layer, molding the formed layers under heat and pressure into a board of a desired thickness, and foaming the natural products immediately before or during a pressing step.

16. The process according to claim 15, wherein the at least one central layer has added to it fillers of plastics material, which additionally foam up during the pressing step.

17. The process according to claim 15, wherein reinforcing fibers and optionally latent heat storage media are added to the at least one central layer.

18. The woodbase board according to claim 9, wherein the fibrous or filamentary constituents includes flax.

19. The woodbase board according to claim 10, wherein the fibrous or filamentary constituents comprise carbon, PE, PP, PET or of glass fibers.

20. The woodbase board according to claim 12, wherein the plastics material is at least one of polyurethane foams and polystyrene foams.

21. The process according to claim 16, wherein the plastics material comprise at least one of polyurethane foams and polystyrene foams, which foam up during the pressing step.
